(19) United States
(12) Patent Application Publication
(10) Pub. No.: US 2017/0153787 A1
(43) Pub. Date: Jun. 1, 2017

(54) INJECTION OF 3-D VIRTUAL OBJECTS OF MUSEUM ARTIFACT IN AR SPACE AND INTERACTION WITH THE SAME

(71) Applicant: Globalive XMG JV Inc., Toronto (CA)

(72) Inventors: Yousuf Chowdhary, Maple (CA); Steven Blumenfeld, Lafayette, CA (US); Kevin Garland, Toronto (CA)

(21) Appl. No.: 15/293,192

(22) Filed: Oct. 13, 2016

Related U.S. Application Data
(60) Provisional application No. 62/241,212, filed on Oct. 14, 2015.

(51) Int. Cl. G06F 3/0481; G06K 9/00; G09B 5/06; G06F 3/0488; G06F 3/01; G06T 19/00; G06F 3/0484

(52) U.S. Cl. CPC G06F 3/04815; G06T 19/006; G06K 9/00671; G06T 19/003; G06F 3/04845; G06F 3/0488; G06F 3/011; G09B 5/065

(57) ABSTRACT

A method is provided for injecting a 3D virtual museum artifact in augmented reality space for interaction therewith by a user of a mobile device. Through the mobile device, a camera feed of a scene in a museum is acquired, which includes a flat surface. The mobile device selects a key frame of the flat surface from the feed. The mobile device determines that the flat surface in the key frame meets a predetermined level of feature richness. The mobile device accesses a 3D virtual museum artifact from a museum database, which had been previously acquired or extrapolated from an actual museum artifact in the collection of the museum. This is injected over at least a part of the key frame. The user is then allowed to interact with the 3D virtual museum artifact.

### CROSS-REFERENCE TO RELATED APPLICATION

This application claims the benefit of U.S. Provisional Application No. 62/241,212, filed Oct. 14, 2015. The priority application is hereby incorporated herein by reference in its entirety.

### FIELD OF INVENTION

The present invention is related to augmented reality applications in general and more particularly relates to markerless injection of 3D virtual museum artifacts in an augmented reality space and user interaction with same.

### BACKGROUND

Generally a museum is an institution that collects, preserves, interprets, and displays a set of artistic, cultural, historical, scientific, or other artifacts of interest. The displays at the museum may be a mix of fixed and temporary exhibits. Museums have many purposes, but mainly they aim to preserve items of significant historical importance and to educate the public at large.

Over time museums have become boring places where historical artifacts are displayed but not enough relevant information is available to educate or engage the visitor. Although audio guides and interactive displays are generally available for a fee at a museum, such sources are static and become dated after a while. Making changes to update the audio guides and interactive displays is cumbersome, time consuming and thus costly.

Traditional institutions like museums that used to be responsible for delivering these learning experiences are becoming less relevant over time and as a result museums are experiencing declines in attendance on both measures of audience share and size. Young parents with children and young people expect to be educated and entertained at the same time because the leisure industry provides them with fast, fun and more meaningful experiences.

To combat this some museums have installed interactive displays for educational purposes that encourage a more hands-on approach while also offering some level of entertainment. But most of the historical artifacts that are on display are items of great value that have been preserved and are fragile or precious thus not available for physical contact or manipulation by users.

Museums are looking to boost visitors and are unable to attract or fully engage the younger audience that has become used to rich multi-media experiences and is so hooked to its mobile devices. Thus for a museum to be able to attract large numbers of visitors it is important to engage a younger audience with displays and exhibits that are interactive, provide information that is easily accessible via an app on a mobile device, and provide an easy user experience with little or no set up required.

On the spectrum between virtual reality, which creates immersive, computer-generated environments, and the real world, augmented reality is closer to the real world. Augmented reality (AR) refers to the addition of a computer-assisted contextual layer of information over the real world, creating a reality that is enhanced or augmented. The basic idea of augmented reality is to superimpose information in the form of data, graphics, audio and other sensory enhancements (haptic feedback and smell) over a real-world environment as it exists in real time. While augmented reality has been in existence for almost three decades, it has only been in the last few years that the technology has become fast enough and affordable enough for the general population to access. Both video games and cell phones are driving the development of augmented reality. Everyone from tourists, to soldiers, to someone looking for the closest subway stop can now benefit from the ability to place computer-generated information and graphics in their field of vision.

The augmented reality systems use video cameras and other sensor modalities to reconstruct a mixed world that is part real and part virtual. Augmented Reality applications blend virtual images generated by a computer with a real image (for example taken from a camera) viewed by a user.

There are primarily two types of Augmented Reality implementations namely Marker-based and Markerless:
Marker-based implementation utilizes some type of image such as a QR/2D code to produce a result when it is sensed by a reader, typically a camera on a mobile device e.g. a Smartphone
Markerless AR is often more reliant on the sensors in the device being used such as the GPS location, velocity meter, etc. It may also be referred to as Location-based or Position-based AR.

While Markerless Augmented Reality is emerging many markerless AR applications require the use of a built-in GPS to access content tied to a physical location thus superimposing location-based virtual images over the real-world camera feed. Although these capabilities can allow a user to approach a physical location, see digital content in the digital airspace associated with that physical location, and engage with the digital content; such technologies have serious limitations as built-in GPS devices have limited accuracy, cannot work indoors or underground, and may require that a user be connected to a network via WiFi or 4G.

Many AR applications require specialized equipment for example Google Glasses or other head-mounted displays. Although head-mounted displays, or HMDs, have been around for awhile, they are making a comeback as computing devices shrink in size and have better displays and battery life. But this means that the user has to acquire yet another device. This creates a barrier for the creation and presentation of historical, culturally and artistically significant items as virtual objects in an Augmented Reality space for providing a meaningful and engaging user experience.

As mentioned earlier, current museum displays are static and offer little to no user interaction. Emerging technologies like Augmented Reality can provide for an advantageous and engaging user experience that is both new and unique with limitless potentials.

### SUMMARY

Broadly speaking, the present invention relates to a markerless Augmented Reality system and method that injects 3D virtual museum artifacts into AR space when a feature rich flat surface is detected in the camera feed of a mobile device. The systems and methods described here enable a unique and more enjoyable Augmented Reality experience for an audience visiting a museum or other similar venue.

A user may first launch an app (either generic or purpose built) that allows a user to interact with the functionality provided by the system. In one embodiment an application (app) may be directly built into the mobile device's operating system (e.g.: IOS, Android, Windows, OSx, Linux, Chrome etc.), which allows a user to interact with the functionality provided by the system. A graphical user interface may be provided for a user to interact with the app features and to personalize for individual needs.

The user interaction may be one of two different and distinct types or a combination thereof. In a first case the user is relatively stationary in relationship to the flat feature rich surface and manipulates the injected virtual object in the AR space using controls available in the app. In the second case the user is in motion around a certain flat feature rich surface (or a real world 3D object with multiple flat surfaces) in the real world and the AR space shows the different sides of the virtual object as the user moves.

In the preferred embodiment any flat surface with some contrasting features (e.g. contrast of color, or contrast of texture) can be considered a feature rich surface. Thus a smooth black screen may not be considered feature rich as there may not be enough contrast between different points of the surface both in terms of color and texture. Whereas a checkered black and white surface may be considered feature rich as there is enough color contrast between the black and white square. Similarly a brick wall or a concrete surface may be similar in color but will have enough texture on the surface to be considered feature rich.

Some examples of feature rich flat surfaces may include but are not limited to a table, a window, a mirror, a brick floor, a concrete or tiled floor, a wooden floor or fence, a shingled roof, a framed picture, a French door etc. Furthermore any 3 dimensional object that when shot with a single camera may become a 2 dimensional flat surface (as a single camera cannot perceive depth), thus making a soccer ball a flat feature rich surface.

Preferably the app has the capability to connect to the internet and also provides a user an interface which the user may be able to log in or out of the system. The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices e.g. a Smartphone, a tablet, or a personal computer to connect with the system e.g. using a browser on a personal computer to access the website or via an app on a mobile device. Devices where invention can be advantageously used may include but not limited to an iPhone, iPad, Smartphones, Android phones, e-readers, wearable devices, personal computers e.g. laptops, tablet computers, touch-screen computers, other devices with displays that are portable running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

In one embodiment the app acquires a key frame of a given flat surface. The key frame acquisition may be automatic or manual with user assistance. A key frame is a single still image in a sequence of images that occurs at an important point in that sequence e.g. at the start of the sequence, any point when the pose changes etc.

In one embodiment the system determines if the flat surface in the key frame is feature rich by using an algorithm that weights consecutive key frames and determines the best rated feature rich key frame. There are other known methods to assess feature richness.

The app preferably then injects a 3D digital representation of a museum artifact in place of the flat feature rich surface e.g. superimpose a 3D digital object e.g. a member of the royalty dressed in ceremonial clothing used in rituals. The 3D digital object may contain text, graphics, video, audio and other sensory enhancements to create a realistic 3D augmented realty experience for the user for example when a brick wall is encountered in an AR space.

In some embodiments user interaction can consist of manipulating the injected 3D digital representation of a museum artifact in AR space by moving, expanding, contracting, walking through, linking, and changing certain characteristics.

In some embodiments once a 3D digital representation of a museum artifact has been injected into the AR space, a user may be able to interact with such content e.g. walk around the virtual 3D representation of a sarcophagus and by manipulating the controls to move the 3D content around, open its lid, see the contents inside, read a description about or related to the item and its history, change size, zoom in, zoom out, share, forward, save, buy a replica or a 3D or a 2D print etc. made on demand.

In some embodiments once a 3D digital representation of a museum artifact has been injected into the AR space, a user may be able to interact with such content e.g. visit the museum or other website e.g. Wikipedia by virtually touching the 3D digital representation of a museum artifact in the AR space or buy a replica, or any other related or unrelated product/service by virtually touching the 3D digital representation of a museum artifact and optionally paying for it with a digital payment method e.g. automatically paying from a credit card linked to the user's Smartphone, or using a Paypal account of the user and the like.

The user may use any one of the several possible mechanisms to interact with the 3D digital representation of a museum artifact and other injected content in the AR space including but not limited to a touchscreen, keyboard, voice commands, eye movements, gamepad, mouse, joystick, wired game controller, wireless remote game controller or other such mechanism.

A user may have to provide a user name and a password along with other personal or financial information in order to create an account. Personal information for example may include providing address and date of birth (age), gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate content in the AR space that fit the user profile.

A user may optionally provide access to the user's social graph or online personality to ascertain personal, family, friend's, acquaintance's information including but not limited to location, address and date of birth (age), gender, sexual orientation, family status and size, tastes, likes and dislikes and other information related to work, habits, hobbies etc. Preferably financial information may include providing a credit card number, an expiry date and billing address or other information like PayPal account details etc.

The 3D or other digital content that is injected may be specifically selected for particular relevance to the user based on aspects of the user's preferences or profile. For example a person with casual interest in history may be shown 3D digital content that are related to the subject of interest; while a person who is deep interest a particular era or a ruling dynasty may be shown 3D content along with audio and text guides, lineage and ruling members of the dynasty, information about wars and weapons and their advancement in the dynasty etc.

In one embodiment age appropriate content may be displayed to a user based on the user's age; while the complexity and the extent of the content may also vary with age e.g. teens may be provided with a set of easy to understand information including gamified content (concept of applying game mechanics and game design techniques to engage and motivate users to achieve their goals); while older adults may be provided more in depth commentary and details. Preferably a user may be able to control the complexity and the extent of the content that is injected into the AR space e.g. a teen who is keenly interested in an artifact may want further information after having experienced the age appropriate content.

In some embodiments the 3D or other digital content injected to replace the flat feature rich surfaces may be based on past experience and behavior in addition to the user profile and preferences; e.g. previous patterns of movement in the museum, areas of interest etc. may have an impact on the types and extent of the digital content that is displayed.

In some embodiments the 3D or other digital content injected to replace the flat feature rich surfaces may be based on the user's social profile, interaction with social media and friends along with places visited e.g. other museums, historical cities and sites, locations tagged on a social network like Facebook.

In some embodiments the 3D or other digital content injected to replace the flat feature rich surfaces may be based on user behaviour e.g. browsing history captured via cookies. In some embodiments the system itself may create cookies for storing history specific to the Augmented Reality. Such cookies may maintain a complete or partial record of the state of an object and maintain a record of AR objects (data) that may be used at specific locations amongst other data that may be relevant to an AR experience.

Websites store cookies by automatically storing a text file containing encrypted data on a user's computing device e.g. a Smartphone or a browser the moment the user starts browsing on an online webpage. There are two types of cookies, permanent and temporary cookies. Both have the same capability, which is to create a log/history of the user's online behavior to facilitate future visits to the said website. In Cookie profiling, or web profiling cookies are used to collect and create a profile about a user. Collated data may include browsing habits, demographic data, and statistical information amongst other things and is used for targeted marketing. Social networks may utilizes cookies in order to monitor its users and may use two kinds of cookies; these two are inserted in the browser when a user signs up, while only one of them is inserted when a user lands on the homepage but does not sign up. Additionally, social networks may use different parameters for logged-in users, logged-off members, and non-members.

In one embodiment the feature rich flat surface may be attached permanently or removably to a museum display case. There may be more than one feature rich flat surfaces attached to a museum display case, so that multiple visitors can have the AR experience at the same time. In some embodiments the more than one feature rich flat surfaces attached to the museum display case may display the same 3D digital content while alternative embodiments may have different 3D content items associated with each of the surfaces.

In one embodiment the user may preferably have the means for controlling the type, extent and complexity of the 3D content being injected in the AR space by using a GUI (Graphical User Interface) in the app to manage the settings.

According to a first aspect of the invention, a method is provided for injecting a 3D virtual museum artifact in augmented reality space for interaction therewith by a user of a mobile device. Through the mobile device, a camera feed is acquired of a scene in a museum. The scene includes a flat surface. The mobile device selects a key frame of the flat surface from the feed. The mobile device determines that the flat surface in the key frame meets a predetermined level of feature richness. The mobile device accesses a 3D virtual museum artifact from a museum database. The 3D virtual museum artifact had been previously acquired (e.g. 3D scanned, X-rayed, etc.) or extrapolated (e.g. from data or technical details known or assumed about an artifact) from an actual museum artifact in the collection of the museum. The 3D virtual museum artifact is injected over at least a part of the key frame. The user is allowed to interact with the 3D virtual museum artifact.

If the user is detected to be stationary, the user may be permitted to perform selecting and moving interactions. Such moving interactions may include: resizing, rescaling, relocating, zooming in/out, and reorienting the 3D virtual museum artifact. Manipulators may be provided for the user to perform moving interactions on the 3D virtual museum artifact. Such selecting and moving interactions may be performed on the mobile device, e.g. on a touchscreen of the mobile device. Such selecting and moving interactions may also be performed by virtually touching the 3D virtual museum artifact in augmented reality space.

If the user is detected to be in motion, the user may be permitted to interact with the 3D virtual museum artifact by walking around or through the 3D virtual museum artifact in augmented reality space. If the user is detected to be in motion, the 3D virtual museum artifact may be automatically moved in accordance with the movements of the user in augmented reality space.

The user may be allowed to see a surface or portion of the 3D virtual museum artifact, wherein the corresponding surface or portion of the actual museum artifact is ordinarily hidden.

The user may be allowed to virtually open the 3D virtual museum artifact, or virtually uncover or remove at least one layer of the 3D virtual museum artifact, wherein the corresponding actual museum artifact is otherwise closed or covered or not exposed.

Interacting with the 3D virtual museum artifact preferably includes obtaining further information on the actual museum artifact. For example, the user may be directed to related actual or virtual museum artifacts in the museum.

Interacting with the 3D virtual museum artifact may include requesting or purchasing a 2D or 3D replica of the actual museum artifact. Such replicas may be printed or generated in the museum to order.

Interacting with the 3D virtual museum artifact may involve the user in a game or movie about the museum artifact.

In some embodiments, the interactions are selected based on user profile. For example, the interactions may be selected based on age or grade level (or interests) of the user.

The flat surface is preferably in a marked or otherwise designated area in the museum. The flat surface may be in an area of the museum that is proximate to where the corresponding actual museum artifact is exhibited.

The method may include detecting the proximity of the mobile device to an actual museum artifact (e.g. through RFID tags, QR codes, etc., or by taking a reading or reckoning of the location of the mobile device and correlating this with known locations of artifacts). The 3D virtual museum artifact may only be injected when the mobile device is within a preselected proximity threshold.

While some exemplary methods and schemes have been given, the invention is not limited to these examples, in fact the invention may use any other kind of method or scheme and the intent is to cover all such methods known to ones familiar with the art.

### BRIEF DESCRIPTION OF THE FIGURES

FIG. 1 is a flow diagram of a basic outline of the present method.

FIG. 2 is a flow diagram with more specific detail as to user interaction and feedback.

FIG. 3 is a flow diagram with more specific detail as to acquiring a key frame, evaluating feature richness and injecting a 3D virtual object (museum artifact).

FIG. 4 is a flow diagram with more specific detail as to feature richness evaluation.

FIG. 5 is a flow diagram with more specific detail as to pose estimation.

FIG. 6 is a flow diagram with more specific detail as to interaction by moving around a 3D virtual object (museum artifact) in augmented reality space.

### DETAILED DESCRIPTION

Methods and arrangements for injecting ads in markerless augmented reality spaces are disclosed in this application whereby when a flat feature rich surface is encountered in the camera feed, a corresponding virtual 3D museum artifact is injected into the AR space to partially or totally replace the flat surface. The application relates to and builds upon prior inventions of the applicants, described in U.S. patent application Ser. No. 15/229,066, filed Aug. 4, 2016, and U.S. patent application Ser. No. 15,272,056, filed Sep. 21, 2016, both of which are incorporated herein by reference.

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements. However, it will be understood that, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Python, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

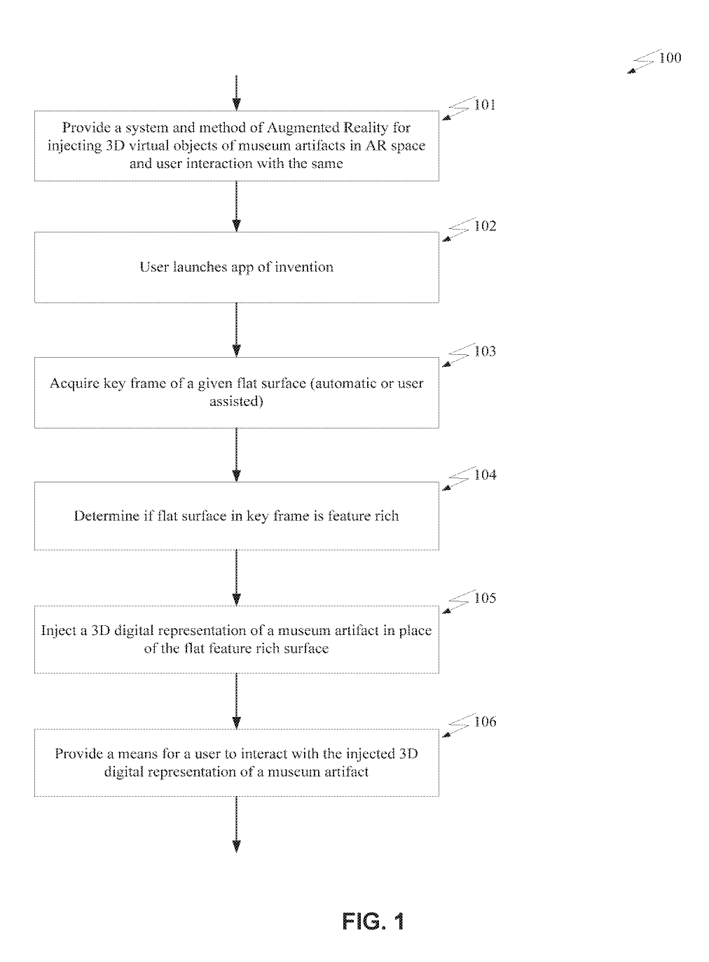

FIG. 1 shows the basic flow of the main method 100. A system and method are provided for injecting 3D virtual objects of museum artifacts in AR space and user interaction with the same when a flat feature rich surface is recognized in a camera feed 101.

Preferably, any flat surface with some contrasting features (e.g. contrast of color, or contrast of texture) can be considered a feature rich surface. Thus a smooth black screen may not be considered feature rich as there may not be any contrast between different points of the surface both in terms of color and texture. Whereas a checkered black and white surface may be considered feature rich as there is enough color contrast between the black and white square. Similarly a brick wall or a concrete surface may be similar in color but may have enough texture on the surface to be considered feature rich.

The feature rich flat surface may be attached permanently or removably to a museum display case. The museum display case may include more than one feature rich flat surfaces attached, so that multiple visitors can have the AR experience at the same time. In some embodiments the more than one feature rich flat surfaces attached to the museum display case may display the same 3D digital content. While alternative embodiments may have different 3D or other digital content items associated with each of the flat feature rich surfaces e.g. audio, video, text, etc.

Some examples of feature rich flat surfaces may include but are not limited to a table, a window, a mirror, a brick wall or floor, a concrete wall, floor or roof, a tiled wall, floor or wall, a wooden wall, floor or fence, a shingled roof, a framed picture, a French door etc. Furthermore any 3 dimensional object that when shot with a single camera may become a 2 dimensional flat surface (as a single camera cannot perceive depth), thus making a soccer ball a flat feature rich surface.

Initially, a user launches an app implementing the system and method 102. The app may be either generic or purpose built. It allows the user to interact with the functionality provided by the system. In one embodiment the application (app) may be directly built into the device's operating system (e.g.: IOS, Android, Windows, OSx, Linux, Chrome etc.), which allows a user to interact with the functionality provided by the system. A graphical user interface may be provided for a user to interact with the app features and to personalize for individual needs.

Preferably the app has the capability to connect to the internet and also provides a user an interface which the user may be able to log in or out of the system.

The application may be specific for a particular mobile device e.g. an iPhone or a Google Android phone, or a tablet computer etc. or generic e.g. Flash or HTML5 based app that can be used in a browser. In one embodiment the app may be downloaded from a branded Application Store.

Users may use connected devices e.g. a Smartphone, a tablet, or a personal computer to connect with the system e.g. using a browser on a personal computer to access the website or via an app on a mobile device. Devices where the invention can be advantageously used may include but not limited to an iPhone, iPad, Smartphones, Android phones, Head Mounted Displays (HMDs), e-readers, wearable devices, personal computers e.g. laptops, tablet computers, touch-screen computers and other devices that have a display and are portable running any number of different operating systems e.g. MS Windows, Apple iOS, Linux, Ubuntu, etc.

In some embodiments, the device is portable. In some embodiments, the device has a touch-sensitive display with a graphical user interface (GUI), one or more processors, one or more cameras, memory and one or more modules, programs or sets of instructions stored in the memory for performing multiple functions. In some embodiments, the user interacts with the GUI primarily through finger contacts and gestures on the touch-sensitive display. Instructions for performing different functions may be included in a computer readable storage medium or other computer program product configured for execution by one or more processors.

A key frame of a given flat surface is acquired (automatic or user assisted) 103. A key frame is a single still image in a sequence of images that occurs at an important point in that sequence e.g. at the start of the sequence, any point when the pose changes etc.

It is determined whether the flat surface in key frame is feature rich 104. For example, feature richness may be assessed by using an algorithm that weights consecutive key frames and determines the best rated feature rich key frame. Other methods are possible.

Provided the surface is sufficiently feature rich, a 3D digital representation of a museum artifact is injected in place of the flat feature rich surface 105. In one embodiment the app injects a 3D digital representation of a museum artifact in place of the flat feature rich surface e.g. superimpose a 3D digital representation e.g. an Egyptian mummy in the AR space using the camera feed as the background. The 3D digital representation of a museum artifact may also contain text, graphics, video, audio and other sensory enhancements to create a realistic 3D augmented realty experience for the user for example when a flat surface like a cardboard square attached to the wall besides the displayed real world museum artifact is encountered in an AR space.

The user may have to provide a user name and a password along with other personal or financial information in order to create an account. Personal information for example may include providing address and date of birth, gender, sexual orientation, family status and size, tastes, likes and dislikes and other information related to work, habits, hobbies etc. Financial information may include providing a credit card number, an expiry date and billing address to be used for financial transactions. Creating a user account is a well understood method in prior art. The information gathered via such a user account creation and customization may be used for injecting the appropriate ads that fit the user profile.

The user may optionally provide access to the users social graph or online personality to ascertain personal, family, friend's, acquaintance's information including but not limited to location, address and date of birth (age), gender, sexual orientation, family status and size, tastes, likes and dislikes and other information related to work, habits, hobbies etc. Preferably financial information may include providing a credit card number, an expiry date and billing address or other information like PayPal account details etc.

The user may use any one of several means for interacting with the injected 3D digital representation of a museum artifact 106. For example, user interaction can consist of manipulating the injected digital object by moving, expanding, contracting, walking through, linking, and changing certain characteristics.

The user interaction may be one of the two different and distinct types or a combination thereof:
1) User is relatively stationary: User is relatively stationary in relationship to the flat feature rich surface and manipulates the injected virtual object in the AR space using controls. Manipulation tasks involve selecting and moving a 3D digital object. Thus the user in this case is generally stationary and uses controls on the screen or keyboard to move, resize, relocate the object in AR space. For example a 3D representation of a mummy is injected in the AR space when a purpose built cardboard square attached to the wall besides the real world exhibit on display and the user is able to manipulate the inject 3D representation to see the underside that is not visible in the real world exhibit.
2) User Moves: For example the user walks around a virtual 3D object. In this case the user actually moves around a certain flat feature rich surface in the real world and the AR space shows the different sides of the virtual object that is a representation of the museum exhibit or an item associated with it, as the user moves. For example a 3D representation of a statue is injected in the AR space and the user is able to move around the flat feature rich surface e.g. a purpose built cube made of cardboard or other material and see the aspects of the statue that are not visible in the real world exhibit, e.g. see the statue from above.

In one embodiment 3D widgets also known as manipulators can be used to put controls on the injected 3D digital representation. Users can then employ these manipulators to re-locate, re-scale or re-orient the 3D digital representation (Translate, Scale, Rotate).

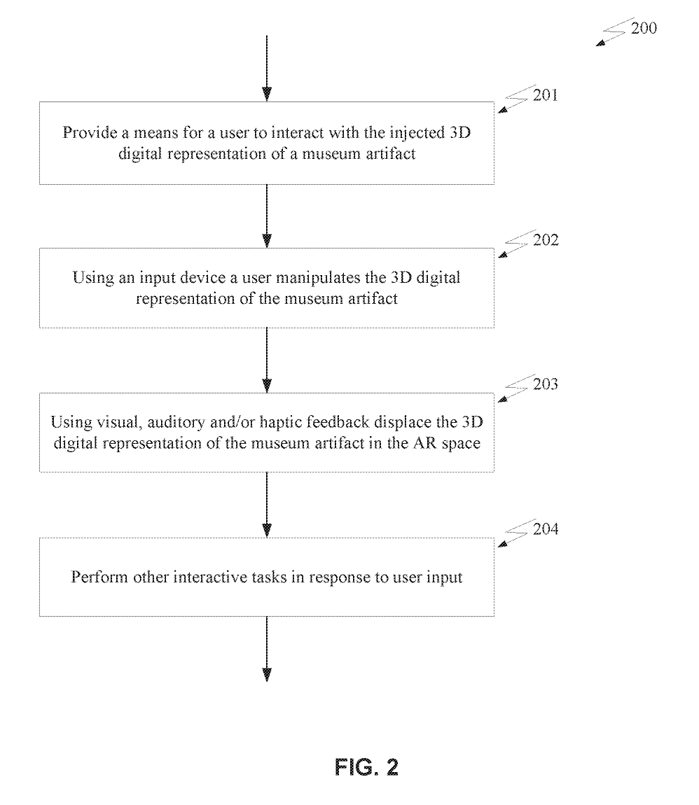

FIG. 2 provides a flow chart of user interaction with the injected 3D digital representation of the museum artifact according to the preferred embodiment 200.

A means is provided for a user to interact with the injected 3D digital representation of the museum artifact 201. For example, a user may use any one of the several possible mechanisms to interact with the injected virtual object in the AR space including but not limited to a touchscreen, keyboard, voice commands, eye movements, gamepad, mouse, joystick, wired game controller, wireless remote game controller or other such mechanism.

Using an input device a user manipulates the 3D digital representation of the museum artifact 202. In one embodiment using an input device a user manipulates the 3D digital representation of the museum artifact or other related content. For example a user may employ one or more of the following to interact with the 3D digital content:
Touchscreen interaction
Graphical menus
Voice commands
Gestural interaction
Virtual tools with specific functions

Using visual, auditory and/or haptic feedback, the 3D digital representation of the museum artifact may be displaced in the AR space 203.

Other interactive tasks may be performed in response to user input 204.

In some embodiments user interaction can consist of manipulating the injected AR digital museum artifact by moving, expanding, contracting, walking through, linking, and changing certain characteristics of the injected 3D content.

In some other embodiments user interaction can consist of visiting a website e.g. Wikipedia by virtually touching the 3D digital representation of a museum artifact in the AR space or buy a replica or other the product/service by virtually touching the digital content in the AR space and optionally paying for it with a digital payment method e.g. automatically paying from a credit card linked to the user's Smartphone, or using a PayPal account of the user and the like.

Examples of interaction with the 3D digital ads may include but are not limited to the following:
1. Re-locate (Translate)
2. Re-scale (Scale)
3. Re-orient (Rotate along X, Y and Z axis)
4. Zoom in and Zoom out
5. Read information about the museum artifact (inject an image of text)
6. Listen to an audio clip regarding the artifact (inject an audio clip)
7. Watch a movie about the artifact (inject a movie clip)
8. Purchase a replica of the artifact
9. Take a screen shot or make a movie of the virtual object injected and share
10. Walk around the actual museum artifact and see the hidden sides/areas not visible in the display (inject a 3D virtual representation of the museum artifact)
11. Move around the flat feature rich surface and see the hidden sides/areas not visible in the display of the museum artifact (Example 1: A mummy is on display, but only some portions are visible; with this technique, see the sides not visible otherwise. Example 2: View a large statue from the top by seeing a virtual view of the top).

112. Remove layers in a painting to see how the artist sketched and changed the painting (inject multiple images and the user can go from one to the other while removing layers)

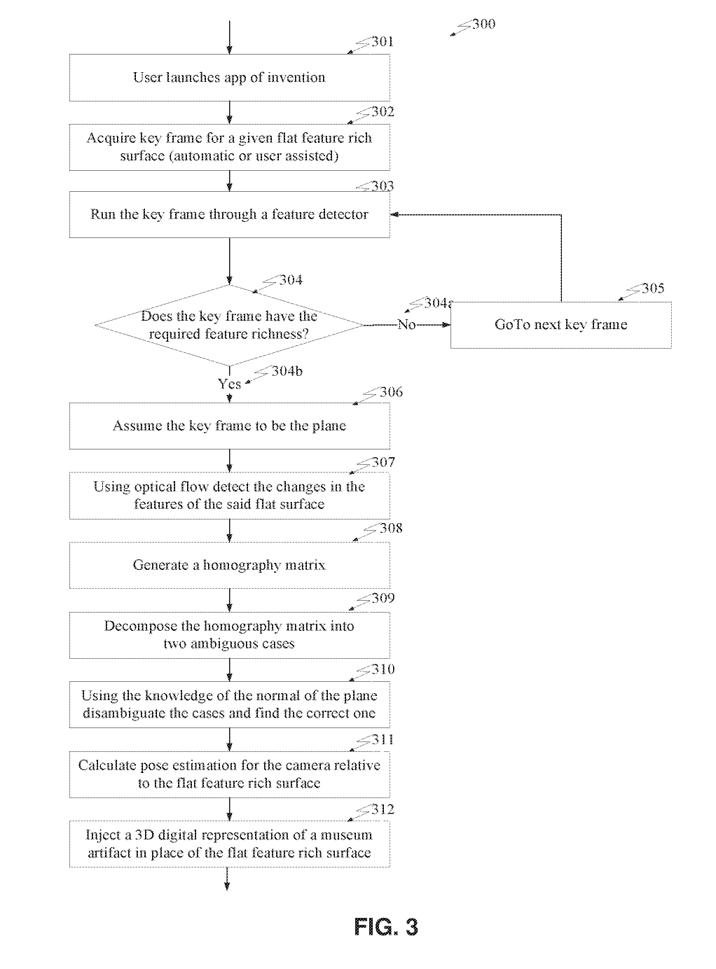

FIG. 3 provides a flow chart of pose estimation with the system of invention according to the preferred embodiment of the invention 300.

The user launches the app 301 on a mobile device e.g. a Smartphone or a tablet. The app may be downloaded by a user from an AppStore or may come bundled and pre-loaded with the mobile device.

A key frame is acquired for a given flat feature rich surface (automatic or user assisted) 302. In one embodiment app acquires key frame of a given flat surface using the camera built into the mobile device. In one embodiment the key frame acquisition may be automatic or may be manual with user assistance. A key frame is a single still image in a sequence that occurs at an important point in that sequence.

The key frame is run through a feature detector 303. A feature is defined as an “interesting” part of an image, and features are used as a starting point and main primitives for subsequent algorithms for many computer vision algorithms. Feature detection is a process in computer vision that aims to find visual features within the image with particular desirable properties.

The feature detection algorithm may execute locally on the user's device while in another embodiment of the invention it may execute on a remote server that is accessible over a network e.g. the internet. In the embodiment where the feature detection is done remotely, an image from the user's device is sent over a connection (wired / wireless/ optical etc.) to a remote computing device (e.g. a standalone computer or a server farm) where the feature detection algorithm is executed. The computed results can then be used by the remote server to select the appropriate 3D digital representation of a museum artifact to be sent to the user's device for selection and insertion of appropriate 3D digital representation of a museum artifact.

In some embodiments the system may use a continuous process for example the video stream or a series of stills may be continuously used for acquiring a key frame and then determining if the flat surface in the key frame has the requisite feature richness.

In some embodiments the detected features are some subsection of the key frame and can be points (e.g. Harris corners), connected image regions (e.g. DoG or MSER regions), continuous curves in the image etc. Interesting properties in a key frame can include invariance to noise, perspective transformations and viewpoint changes (camera translation and rotation), scaling (for use in visual feature matching), or properties interesting for specific usages (e.g. visual tracking).

The system determines whether the key frame has the required feature richness 304 as necessitated by a given implementation. If No 304a, the key frame is missing the required features, then the process moves to the next key frame 305. In some embodiments this process may be continuous such that the feature detection process continues till a key frame with specific feature richness is detected.

If Yes 304b, the key frame has the requisite feature richness, then the system assumes the key frame to be the plane 306 comprising the flat surface.

Using optical flow, the system detects any changes in the features of the flat surface 307.

The system may generate a homography matrix 308. In the field of computer vision, any two images of the same planar surface in space are related by a homography (assuming a pinhole camera model). Homography is used for image rectification, image registration, or computation of camera motion (rotation and translation) between two images. Two images are related by a homography if and only if:
Both images are viewing the same plane from a different angle
Both images are taken from the same camera but from a different angle
Camera is rotated about its center of projection without any translation

It is important to note that the homography relationship is independent of the scene structure and it does not depend on what the cameras are looking at and the relationship holds regardless of what is seen in the images. A homography is a 3 by 3 matrix M:

$$M = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ]$$

If the rotation R of a camera and calibration K are known, then homography M can be computed directly. Applying this homography to one image yields the image that would be obtained if the camera was rotated by R.

The homography matrix is decomposed into two ambiguous cases 309. Using the knowledge of the normal of the plane disambiguate the cases and find the correct one 310.

The pose estimation is calculated for the camera relative to the flat feature rich surface 311.

A 3D digital representation of the museum artifact is injected in place of the flat feature rich surface 312. Once camera rotation and translation have been extracted from an estimated homography matrix, this information may be used for navigation, or to insert models of 3D objects into an image or video, so that they are rendered with the correct perspective and appear to have been part of the original scene.

The content that is injected is preferably selected to be particularly relevant to the user. For example a person with casual interest in history may be shown 3D digital content that are related to the subject of interest; while a person who is deep interest a particular era or a ruling dynasty may be shown 3D content along with audio and text guides, lineage and ruling members of the dynasty, information about wars and weapons and their advancement in the dynasty etc.

In some embodiments the 3D or other digital content injected to replace the flat feature rich surfaces may be based on past experience and behavior in addition to the user profile and preferences; e.g. previous patterns of movement in the museum, areas of interest etc. may have an impact on the types and extent of the digital content that is displayed.

In some embodiments the 3D digital representation of the museum artifact or other 2D or 3D digital content injected to replace the flat feature rich surfaces may be based on the user's social profile, interaction with social media and friends along with places visited e.g. other museums, historical cities and sites, locations tagged on a social network like Facebook.

In some embodiments the 3D digital representation of the museum artifact injected to replace the flat feature rich surfaces may be based on user behaviour e.g. browsing history captured via cookies. In some embodiments the invention itself may create cookies for storing history specific to the Augmented Reality. Such cookies may maintain a complete or partial record of the state of an object and maintain a record of AR objects (data) that may be used at specific locations amongst other data that may be relevant to an AR experience.

In some embodiments the 3D digital representation of the museum artifact injected to replace the flat feature rich surfaces may be based on user behaviour e.g. browsing history captured via cookies. Websites store cookies by automatically storing a text file containing encrypted data on a user's computing device e.g. a Smartphone or a browser the moment the user starts browsing on an online webpage. There are two types of cookies, permanent and temporary cookies. Both have the same capability, which is to create a log/history of the user's online behavior to facilitate future visits to the said website. In Cookie profiling, or web profiling cookies are used to collect and create a profile about a user. Collated data may include browsing habits, demographic data, and statistical information amongst other things and is used for targeted marketing. Social networks may utilizes cookies in order to monitor its users and may use two kinds of cookies; these two are inserted in the browser when a user signs up, while only one of them is inserted when a user lands on the homepage but does not sign up. Additionally, social networks may use different parameters for logged-in users, logged-off members, and non-members.

While several examples have been given to illustrate the system and method, the invention is not limited to these examples, in fact the invention may use any other kind of method or scheme for injecting content related or unrelated to the museum artifact on display.

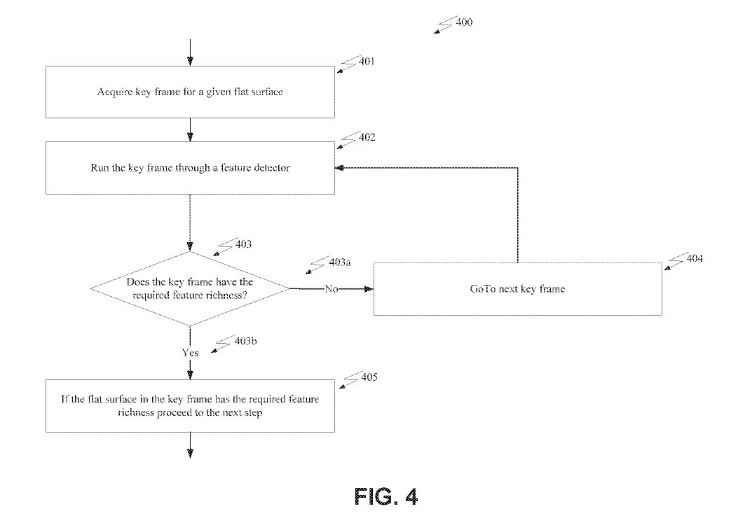

Referring to FIG. 4, a flow chart is provided of the process for determining if a flat surface is feature rich 400. A key frame for a given flat surface is acquired 401. A key frame is a single still image in a sequence of images that occurs at an important point in that particular sequence of images.

The key frame is run through a feature detector 402. A feature may be defined as an “interesting” part of an image; in the disclosed invention it refers to a flat surface that may have texture or color contrast e.g. a brick wall, or a concrete floor or a checkered board, and the like.

Feature detection is a low-level image processing operation that aims to find visual features within the image with particular desirable properties e.g. a flat feature rich surface. In one embodiment the feature detection refers to methods that aim at computing abstractions of image information and making local decisions at every image point whether there is an image feature of a given type at that point or not.

The system determines whether the key frame has the required feature richness 403. In one embodiment feature detection is performed as the first operation on an image (key frame), and examines every pixel in it and then compares the individual pixels to determine if the compared pixels are sufficiently different e.g. there is sufficient color contrast between the compared pixels for the flat surface to have a contrast.

If the flat surface in the key frame does not have the required feature richness 403a the system proceeds to the next key frame and continues the process.

If the flat surface in the key frame has the required feature richness 403b then the system proceeds to the next step 404 of injecting a 3D digital representation of the museum artifact in the AR space where the flat feature rich surface is located.

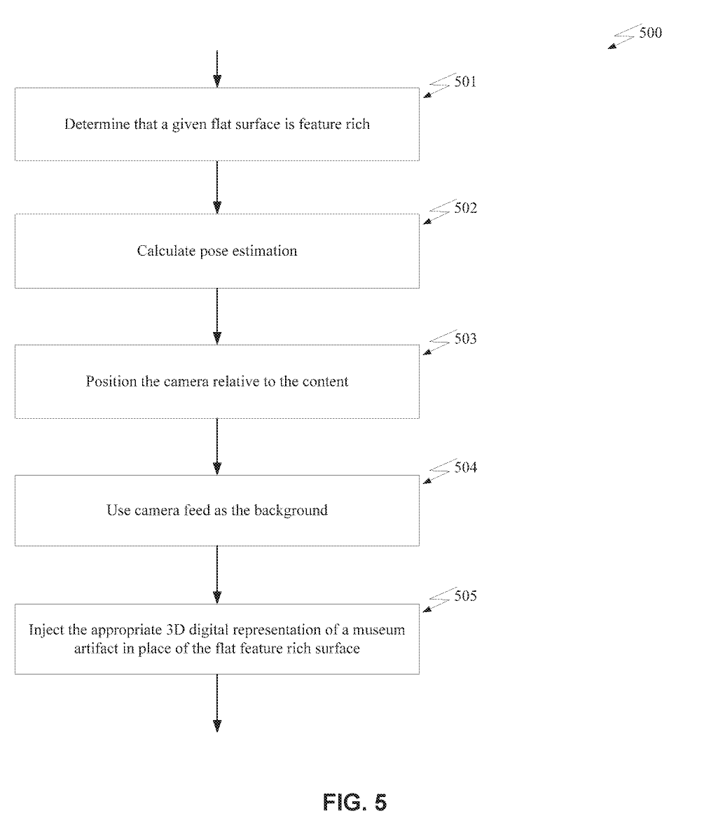

Referring to FIG. 5, a flow chart is provided of the process for the injection of digital content in place of the flat feature rich surface in the Augmented Reality space 500.

The system determines whether a given flat surface is feature rich 501.

Provided it is sufficiently feature rich, the system calculates a pose estimation 502. In computer vision a typical task is to identify specific objects in an image and to determine each object's position and orientation relative to some coordinate system. The combination of position and orientation is referred to as the pose of an object, even though this concept is sometimes used only to describe the orientation. This information can then be used, for example, to allow a computer to manipulate an object or to inject a virtual object into the image in place of the real object in the video steam.

The pose can be described by means of a rotation and translation transformation which brings the object from a reference pose to the observed pose. This rotation transformation can be represented in different ways, e.g., as a rotation matrix or a quaternion.

The specific task of determining the pose of an object in an image (or stereo images, image sequence) is referred to as pose estimation. The pose estimation problem can be solved in different ways depending on the image sensor configuration, and choice of methodology. Three classes of methodologies can be distinguished:
Analytic or geometric methods: Given that the image sensor (camera) is calibrated the mapping from 3D points in the scene and 2D points in the image is known. If also the geometry of the object is known, it means that the projected image of the object on the camera image is a well-known function of the object's pose. Once a set of control points on the object, typically corners or other feature points, has been identified it is then possible to solve the pose transformation from a set of equations which relate the 3D coordinates of the points with their 2D image coordinates. Algorithms that determine the pose of a point cloud with respect to another point cloud are known as point set registration algorithms, if the correspondences between points are not already known.
Genetic algorithm methods: If the pose of an object does not have to be computed in real-time a genetic algorithm may be used. This approach is robust especially when the images are not perfectly calibrated. In this particular case, the pose represent the genetic representation and the error between the projection of the object control points with the image is the fitness function.
Learning-based methods: These methods use artificial learning-based systems which learn the mapping from 2D image features to pose transformation. This means that a sufficiently large set of images of the flat surface (in different poses) must be presented to the system during a learning phase. Once the learning phase is completed, the system is able to present an estimate of the pose of the flat surface and digital ads can be inserted in place of the flat feature rich surface with the same pose.

The preferred embodiment may use the analytic or geometric methods for pose estimation, while other embodiments may use different methods best suited to the particular implementations.

The camera is positioned relative to the content 503. Once camera rotation and translation have been extracted from an estimated homography matrix, this information may be used for navigation, or to insert models of 3D objects into an image or video, so that they are rendered with the correct perspective and appear to have been part of the original scene.

The camera feed is used as the background 504, and the appropriate 3D digital representation of the museum artifact is injected in place of the flat feature rich surface 505. For example a virtual object that represents the pyramid may be injected where a sarcophagus with the mummy on display was discovered. For example a user may be able to manipulate the digital content to see its different aspects, walk through the AR space as if walking in the burial chamber and see the different items found inside, read or listen to a commentary about these items etc.

In some embodiments the 3D virtual object may also be accompanied with superimposed graphics, video, audio and other sensory enhancements like haptic feedback and smell to create a realistic augmented realty experience for the user.

In other embodiments a user may have to pay e.g. get a membership to a museum for viewing the injected content. While in other embodiments the user may access the injected content using a pay as you go method of payment. Other embodiments may provide some free or subsidized 3D content related to the museum artifacts in compensation for watching and interacting with ads injected in the AR space.

In some embodiments once a digital content has been injected into the AR space, a user may be able to interact with such content e.g. see the virtual 3D representation of a statue on display from different angles by manipulating the controls to move the 3D content, change size, zoom in, zoom out, share, forward, save, buy a replica or create a 3D print etc.

In some embodiments the interaction may also include but is not limited to e.g. be able to visit the museum or other related website by virtually touching the 3D digital representation of a museum artifact in the AR space by virtually touching the digital content and optionally paying for it with a digital payment method e.g. automatically paying from a credit card linked to the user's Smartphone, or using a PayPal account of the user and the like.

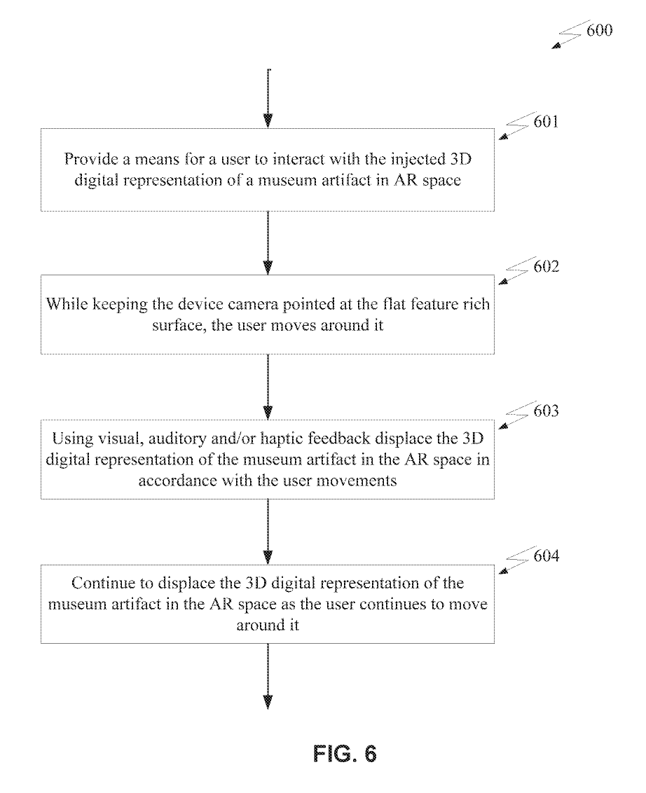

Referring to FIG. 6, a flow chart is provided of the process a user interacting with the 3D digital representation of the museum artifact which has been injected in place of the flat feature rich surface in the Augmented Reality space 600.

A means is provided for a user to interact with the injected 3D digital representation of the museum artifact 601. For example means may be provided for a user to be able to walk around the flat feature rich surface to experience the different sides of a pyramid that has been injected in the AR space.

While keeping the device camera pointed at the flat feature rich surface, the user moves around it 602, e.g. from the front to the right side or to the back side of the flat feature rich surface.

Using visual, auditory and/or haptic feedback, displace the 3D digital representation of the museum artifact in the AR space in accordance with the user movements 603. In one embodiment using visual, auditory and/or haptic feedback displace the 3D digital representation of the museum artifact in the AR space in accordance with the user movements e.g. when the user moves to the right side of the flat feature rich surface, display the right side of the pyramid etc.

Tactile haptic feedback has become a commonly implemented technology in mobile devices, and in most cases, this takes the form of vibration response to touch. Haptic technology, haptics, or kinesthetic communication, is tactile feedback technology which recreates the sense of touch by applying forces, vibrations, air or motions to the user. This mechanical stimulation can be used to assist in the creation of virtual objects in a computer simulation, to control such virtual objects, and to enhance the remote control of machines and devices.

The system continues to displace the 3D digital representation of a museum artifact in the AR space as the user continues to move around it 604, e.g. from the front of the flat feature rich surface to the right side and then to the back side and then to the left side before reaching the front side again.

Multiple types of content may be injected in place of the flat feature rich object that is 3 dimensional and that can be broken down into multiple flat feature rich surfaces. For example a 3D object like a box which has 6 flat feature rich surfaces may be placed strategically next to a museum display; thus multiple 3D virtual objects and other digital content may be injected into the AR space. For example different virtual objects may be associated with each of the six sides of the box, such that the virtual object associated with the surface facing the user may be displayed in the AR space.

In some embodiments each surface may be associated with a different type of digital content such that one side may have text, another audio, yet another video etc. associated with it and this digital content is then injected in the AR space when a user's mobile device camera is pointing at said surface.

For example 3D digital content related to different eras of a dynasty may be associated with each of the different sides of the 3D real world object.

In another embodiment 3D digital content related to the museum artifact may increase in complexity and extent as a user moves around a 3D real world object with multiple feature rich flat surfaces.

In some embodiments the 3D or other content associated with a multi-dimensional real world object with more than one flat feature rich surfaces may be gamified such that the user progresses from an easier level to a more complex level as the user moves around the said real world object.

In some embodiments the 3D or other content associated with a multi-dimensional real world object with more than one flat feature rich surfaces may be downloaded (either automatically or by user request) from a central server that acts as a repository for such digital and virtual content.

In one embodiment the user may preferably have the means for controlling the type, extent and complexity of the 3D content being injected in the AR space by using a GUI (Graphical User Interface) in the app of invention to manage the settings. The user may be motivated to do so either to save time or conserve data usage.

In one embodiment age appropriate content may be displayed to a user based on the user's age; while the complexity and the extent of the content may also vary with age e.g. teens may be provided with a set of easy to understand information including gamified content (concept of applying game mechanics and game design techniques to engage and motivate users to achieve their goals); while older adults may be provided more in depth commentary and details. Preferably a user may be able to control the complexity and the extent of the content that is injected into the AR space e.g. a teen who is keenly interested in an artifact may want further information after having experienced the age appropriate content and may opt for advanced level information.

It should be noted that the size and scope of the digital content on the screen of the device is not limited to a particular portion of a user's field of vision as the digital content comprising the virtual content may extend throughout the screen of the mobile device or be sectioned to predetermined viewing dimensions, or dimensions in proportion to the size of the screen.

The digital content displayed on the screen of the mobile device being used for the Augmented Reality experience can be anchored to a particular volume of airspace corresponding to a physical location of the flat feature-rich surface. The mobile device being used for the Augmented Reality experience may display some, or all, of the digital content relative the orientation of the user or screen to the physical location of the flat feature rich surface. That is, if a user is oriented towards the physical location of the flat feature rich surface, the digital content is displayed, but gradually moved and eventually removed as the user moves to become oriented so that the physical location of the flat feature rich surface is not aligned with the user and the screen.

Although the digital content displayed on the screen is not limited to a particular size or position, various embodiments configure the screen of the mobile device being used for the Augmented Reality experience with the capability to render digital content as a variety of different types of media, such as two-dimensional images, three-dimensional images, video, text, executable applications, and customized combinations of the like.

The application is not limited to the cited examples, but the intent is to cover all such areas that may benefit from Augmented Reality to enhance a user experience and provide informative content with which a user can interact.

One embodiment may preferably also provide a framework or an API (Application Programming Interface) that enables a developer to incorporate the functionality of injecting virtual objects/characters/content into an AR space when encountering a flat feature rich surface. Using such a framework or API allows for a more exciting Augmented Reality generation, and eventually allows for more complex and extensive ability to keep a user informed and engaged over a longer duration of time.

It should be understood that although the term app has been used as an example in this disclosure but in essence the term may also imply any other piece of software code where the embodiments of the invention are incorporated. The software application can be implemented in a standalone configuration or in combination with other software programs and is not limited to any particular operating system or programming paradigm described here.

Although AR has been exemplified above with reference to injecting virtual content related to museum artifacts, it should be noted that AR is also associated with many industries and applications. For example, AR can be used in movies, cartoons, computer simulations, medical diagnostics and imaging, video simulations, among others. All of these industries and applications would benefit from aspects of the present invention.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of injecting a 3D virtual museum artifact in augmented reality space for interaction therewith by a user of a mobile device, comprising:
through the mobile device, acquiring a camera feed of a scene in a museum, the scene including a flat surface;
the mobile device selecting a key frame of the flat surface from the feed;
the mobile device determining that the flat surface in the key frame meets a predetermined level of feature richness;
the mobile device accessing a 3D virtual museum artifact from a museum database, the 3D virtual museum artifact having been previously acquired or extrapolated from an actual museum artifact in the collection of the museum, and injecting the 3D virtual museum artifact over at least a part of the key frame; and
allowing the user to interact with the 3D virtual museum artifact.

2. The method of claim 1, wherein if the user is detected to be stationary, the user is permitted to perform selecting and moving interactions.

3. The method of claim 2, wherein the moving interactions include at least one of: resizing, rescaling, relocating, zooming in/out, and reorienting the 3D virtual museum artifact.

4. The method of claim 3, wherein manipulators are provided for the user to perform moving interactions on the 3D virtual museum artifact.

5. The method of claim 2, wherein the selecting and moving interactions are performed on the mobile device.

6. The method of claim 5, wherein the selecting and moving interactions are performed on a touchscreen of the mobile device.

7. The method of claim 2, wherein the selecting and moving interactions are performed by virtually touching the 3D virtual museum artifact in augmented reality space.

8. The method of claim 1, wherein if the user is detected to be in motion, the user is permitted to interact with the 3D virtual museum artifact by walking around or through the 3D virtual museum artifact in augmented reality space.

9. The method of claim 1, wherein if the user is detected to be in motion, the 3D virtual museum artifact is automatically moved in accordance with the movements of the user in augmented reality space.

10. The method of claim 1, further comprising allowing the user to see a surface or portion of the 3D virtual museum artifact, wherein the corresponding surface or portion of the actual museum artifact is ordinarily hidden.

11. The method of claim 1, further comprising allowing the user to virtually open the 3D virtual museum artifact, or virtually uncover or remove at least one layer of the 3D virtual museum artifact, wherein the corresponding actual museum artifact is otherwise closed or covered or not exposed.

12. The method of claim 1, wherein interacting with the 3D virtual museum artifact includes obtaining further information on the actual museum artifact.

13. The method of claim 12, wherein the further information includes directing the user to related actual or virtual museum artifacts in the museum.

14. The method of claim 1, wherein interacting with the 3D virtual museum artifact includes requesting or purchasing a 2D or 3D replica of the actual museum artifact.

15. The method of claim 1, wherein interacting with the 3D virtual museum artifact involves the user in a game or movie about the museum artifact.

16. The method of claim 1, wherein the interactions are selected based on user profile.

17. The method of claim 1, wherein the interactions are selected based on age or grade level of the user.

18. The method of claim 1, wherein the flat surface is in a marked or otherwise designated area in the museum.

19. The method of claim 1, wherein the flat surface is in an area of the museum that is proximate to where the corresponding actual museum artifact is exhibited.

20. The method of claim 1, further comprising detecting the proximity of the mobile device to an actual museum artifact.

21. The method of claim 20, wherein the 3D virtual museum artifact is only injected when the mobile device is within a preselected proximity threshold.
